(19) United States
(12) Patent Application Publication
(10) Pub. No.: US 2003/0126025 A1
(43) Pub. Date: Jul. 3, 2003

(54) Method, system, and storage medium for facilitating procurement of direct and indirect items

(76) Inventors: Gary Powell, Schenectady, NY (US); Adeyinka Adedeji, Albany, NY (US); John Berry, Gansevoort, NY (US); Jeffrey Bowlin, Evansville, IN (US); Susan Brate, Mount Vernon, IN (US); Huib Van den Durpel, Rilland Bath (NL); Theodor Katsoulis, Bergen op Zoom (NL); Matthew Rowe, Slingerlands, NY (US); Frits Richard Schultze, Bergen op Zoom (NL)

Correspondence Address: CANTOR COLBURN, LLP, 55 GRIFFIN ROAD SOUTH, BLOOMFIELD, CT, 06002

(21) Appl. No.: 09/683,425

(22) Filed: Dec. 27, 2001

(51) Int. Cl. G06F 17/60

(52) U.S. Cl. 705/26

(57) ABSTRACT

An exemplary embodiment of the invention relates to a system, method and storage medium for facilitating procurement of direct and indirect items via a cost out tool. The system comprises a cost out distribution network system comprising a server executing the cost out tool; a communications network operably coupled to the server; and a workstation and data storage device in communication with the server via the communications network. The data storage device houses information utilized by the server in executing the cost out tool including legacy data, bucket specifications and specification templates, sourcing data, and a catalog of selected items and suppliers. The system also includes a link to a plurality of supplier systems and a plurality of site systems operably coupled to the cost out distribution network system and supplier systems via the network system. The network system also includes a code structure including a specification code and an item locator for classifying and organizing the direct and indirect items. The method includes implementing a set-up process and maintenance process for carrying out the functions of the cost out tool. Another embodiment includes a storage medium for implementing the method.

### BACKGROUND OF INVENTION

The invention relates to supply chain processes for direct and indirect items, and more particularly, the invention relates to a method, system, and storage medium for facilitating the procurement of direct and indirect items.

Besides raw materials or direct items that are used for production, business enterprises require operational resources (i.e., non-production goods and services that are required, on a daily basis, to maintain regular business operations). These non-production goods are sometimes referred to as indirect items. Types of operational resources include capital equipment, maintenance, repair and operating (MRO) supplies, transportation, energy, and travel expenses. Oftentimes, the process of acquiring these direct and indirect items involves a multitude of divisions and departments within a business, each of which interacts with many different suppliers, for a particular item. Operating resources account for a substantial percentage of the overall spending of a business, yet the procurement processes employed are often not well organized due, in part, to the decentralized approach still used in many businesses. Centralized procurement systems have been recently implemented for automating functions that were previously distributed among various locations.

Operational Resources Management (ORM) solutions have been devised that attempt to facilitate the management of operational resources via the Internet, providing a communications infrastructure in which trading partners can collaborate on buying and selling decisions. Many ORM systems run on standard web browsers that are executable on most computer platforms making them suitable for general business use. Materials Requirements Planning (MRP) systems have been likewise implemented for facilitating the procurement of direct items.

Although these systems provide some convenience over the previous manual procurement systems, many useful features are lacking. For example, many procurement databases house incompatible MRO data including varied descriptions of existing parts or indirect items used by the business. Suppliers often use their own in-house tools for classifying and describing the goods that they sell which, in turn, are conveyed to customers and stored at the customer site. If the customer transacts with many different suppliers, each with their own database tools, this can result in an irreconcilable storage base of useless or undesirable information for the customer. Further, as suppliers and items become obsolete, the database becomes bogged down with unnecessary data, hindering the procurement processes even further. This is further complicated if the customer operates at many sites across the globe, and each site maintains it's own database. Note that in this current process, a customer could be buying a particular item that is described in many different ways in its databases and also described in many different ways in the suppliers” databases. This customer would have realized that she is buying a large number of this item if a standard format of describing the item is maintained in its database and the suppliers' databases. Further, the customer could have received a volume discount on such particular item.

What is needed is a method and system for facilitating the procurement processes whereby direct and indirect items can be organized and consolidated for better selection and cost opportunities.

### SUMMARY OF INVENTION

An exemplary embodiment of the invention relates to a system, method and storage medium for facilitating procurement of direct and indirect items via a cost out tool. The system comprises a cost out distribution network system comprising a server executing the cost out tool; a communications network operably coupled to the server; and a workstation and data storage device in communication with the server via the communications network. The data storage device houses information utilized by the server in executing the cost out tool including legacy data, bucket specifications and specification templates, sourcing data, and a catalog of selected items and suppliers. The system also includes a link to a plurality of supplier systems and a plurality of site systems operably coupled to the cost out distribution network system and supplier systems via the network system. The network system also includes a code structure including a specification code and an item locator for classifying and organizing the direct and indirect items. The method includes implementing a set-up process and maintenance process for carrying out the functions of the cost out tool. Another embodiment includes a storage medium for implementing the method.

The above described and other features are exemplified by the following figures and detailed description.

### BRIEF DESCRIPTION OF DRAWINGS

Referring now to the figures, which are exemplary embodiments, and wherein like elements are numbered alike:

FIG. 1 is a block diagram of a network system for implementing the cost out functions of the tool;

FIG. 2 is a flowchart describing the specification set-up process implemented via the cost out tool;

FIG. 3 is a flowchart describing the specification maintenance process implemented via the cost out tool;

FIG. 4 is a flowchart describing the selection and procurement process implemented via the cost out tool

FIG. 5 is an exemplary specification data sheet for formatting a specification template and creating bucket specifications;

FIG. 6 is an exemplary specification code structure for classifying, organizing, and identifying direct and indirect items; and

FIG. 7 is an exemplary user interface for performing a search for particular items stored in the cost out catalog.

### DETAILED DESCRIPTION

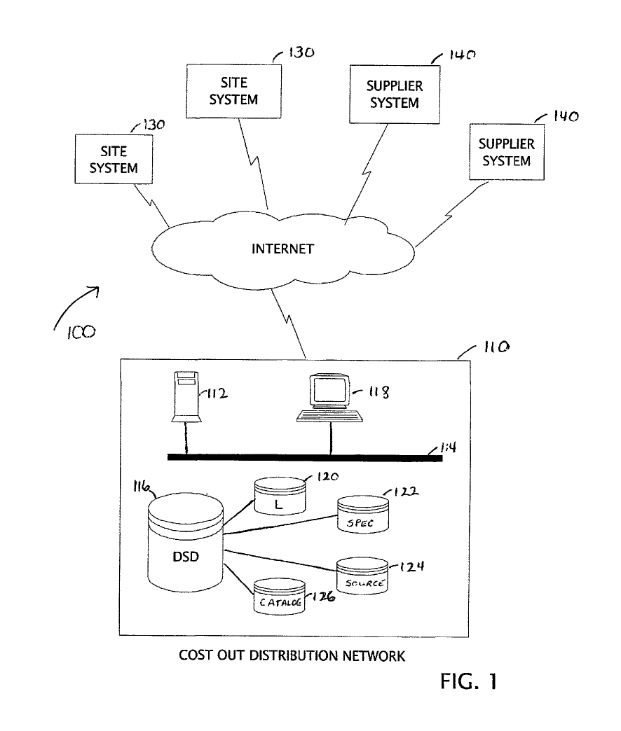

In an exemplary embodiment, the cost out tool is implemented through a networked system such as that shown in FIG. 1. System 100 includes a cost out distribution network system 110 comprising a workstation 118 coupled to a server 112 via a communications network 114 operating in a client/server architecture mode. Cost out distribution network 110 may be a central facility for a business enterprise which executes the cost out tool (e.g., regional/global hub). Additional facilities or hubs may be included in system 100 in order to realize the advantages of the invention. Such might be the case where the business enterprise implementing the cost out tool is a large global enterprise with offices, manufacturing sites, and/or distribution centers dispersed around the world. Workstation 118 may be a general-purpose computer such as a personal computer (PC), laptop, or handheld appliance that includes a processor, memory, and input/output devices. Workstation 118 executes one or more computer programs for carrying out the processes described herein. It should be noted that any number of workstations may be utilized by cost out distribution network 110. Alternatively, workstation 118 may employ applications stored on server 112 wherein workstation 118 operates as a “dumb” client and server 112 carries out the processes described herein with respect to the cost out tool. Typical users of workstation 118 may include information technology (IT) personnel, administrators, management, and subordinate personnel authorized to access the cost out tool. Communications network 114 may comprise a local area network (LAN), a wide area network (WAN), or other network configuration known in the art. Further, network 114 may include wireless connections, radio-based communications, telephony-based communications, and other network-based communications. For purposes of illustration, however, network 114 is a LAN operating in a client/server architecture mode. Cost out distribution network system 110 communicates with external entities via a communications internetwork such as the Internet or an Extranet. In a preferred embodiment, the internetwork of system 100 is the Internet.

Server 112 is running suitable web server software designed to accommodate various forms of network communications, including voice, video, and text. Server 112 preferably operates a web site for conducting network-based auctions and/or negotiations with suppliers and providing suppliers with information. Server 112 executes the cost out tool, one of the applications utilized by cost out distribution network system 110. Server 112 is also running e-mail and groupware applications including bidding/auction tools and through which business transactions and related information are delivered to targeted recipients both inside and outside of cost out distribution network system 110. Server 112 may also be running digital signature software for electronic signature capabilities, as well as database management software and security software. Security features may be achieved via a firewall or similar security device for limiting access to cost out distribution network 110 to those users possessing proper access permissions. For instance, an administrator may have access to the entire system and have authority to modify portions of the system. By contrast, a low level employee on workstation 118 may have the ability to execute programs but not alter the applications or data stored in data storage device 116. It is understood that more than one server may be used.

Server 112 may be coupled to a data storage device 116 via communications network 114. Data storage device 116 is any form of mass storage device configured to read and write database type data maintained in a file store (e.g., a magnetic disk data storage device). It will be appreciated that data storage device 116 may be one that consists of multiple disk sub-systems geographically dispersed and coupled via network architecture. There is no positive requirement that data storage device 116 be maintained in one facility; to the contrary, the volume of information stored therein may dictate geographical dispersion and the like. Data storage device 116 may be logically addressable as a consolidated data source across a distributed environment such as a network system. The implementation of local and wide-area database management systems to achieve the functionality of data storage device 116 will be readily understood by those skilled in the art. Information stored in data storage device 116 may be retrieved and manipulated by database management software executed by server 112. Database management system software may also include a mapping tool for facilitating the integration of selected data stored in various databases associated with data storage device 116. Current mapping tools on the market enable cross-referencing of data fields between two or more databases in order to share and/or consolidate information and are well known in the art. Data storage device 116 contains a variety of information and databases related to the cost out tool as well as proprietary information desired by cost out distribution network 110. Databases 120-126 are associated with data storage device 116. Database 120 comprises a legacy storage system utilized by the business enterprise and may include data similar to that in a MRO procurement database which identifies supplier listings, parts/items descriptions, pricing and contract information, etc. Specification database 122 stores specification templates, bucket specifications, and other related information. Sourcing database 124 houses data related to the bidding, auction, and/or negotiations processes and may include contracts, bid responses, and financial data resulting from the sourcing processes implemented via the cost out tool. Database 126 includes a catalog of selected suppliers, direct/indirect items, prices, etc. that have been compiled and entered for future procurement activities as will be described further herein. Other information that may be stored in data storage device 116 includes security and authorization data; financial data; customer/supplier account information; etc. Data stored in data storage device 116 is accessed by server 112 during presentation of the cost out program to workstation 118 and/or systems 130. Accordingly, the cost out tool preferably includes a graphical user interface and search engine for assisting individuals in accessing its features and functions described herein. It will be understood that data storage device 116 and server 112 may comprise one server/storage unit and that multiple server/storage units may be employed by cost out distribution network 110 in order to realize the advantages of the invention.

Also included in system 100 are site systems 130 which may be in communication with cost out distribution network system 110 via the Internet, Extranet, or other suitable communications technologies. Site systems 130 are generally associated with the business enterprise executing the cost out tool and may include operating entities such as manufacturing plants, industrial facilities, administrative office buildings, etc. Site systems 130 purchase and receive indirect items from suppliers via cost out distribution network 110 and the cost out tool of the invention. The term, “indirect items” refers to items used in running a business but which do not go into the products sold to the consumer. By contrast, direct items refer to items incorporated into finished or partially finished goods. In order to communicate with cost out distribution network 110 and supplier systems 140, site systems 130 may employ suitable web-enabled computer processing devices, systems and applications software, local storage devices, and communications services as are generally known in the art.

Supplier systems 140 receive specifications from cost out distribution network system 110 and the cost out tool and provide feedback on items available for sale in order for comparisons to be made among supplier systems 140 by the business enterprise. Feedback information includes specific bids related to items listed by the business enterprise during the course of an auction or may be “back and forth” offers, terms, and the like during the course of negotiations. The results of these comparisons among responding supplier systems 140 assist the business enterprise in determining which of supplier systems 140 will be designated as “preferred” suppliers for future sourcing activities as will be described further herein. Results of these comparisons may also be used to determine and designate preferred parts approved for future procurement activities. Specifications are generalized, standardized descriptions and identifications of direct and indirect items that are consumed by the business enterprise. The generalized and standardized specifications of the items also allow supplier systems 140 to supply or replace the current items with technically or functionally similar items from different manufacturers as necessary.

It should be noted that although only two site systems 130 and two supplier systems 140 are shown, any number of site systems 130 and supplier systems 140 may be included in system 100 in order to realize the advantages of the invention. It will also be understood that cost out distribution network 110 may be implemented by a site such as one of site systems 130 whereby the business enterprise is a smaller entity. Further, site systems 130 and supplier systems 140 could be located worldwide.

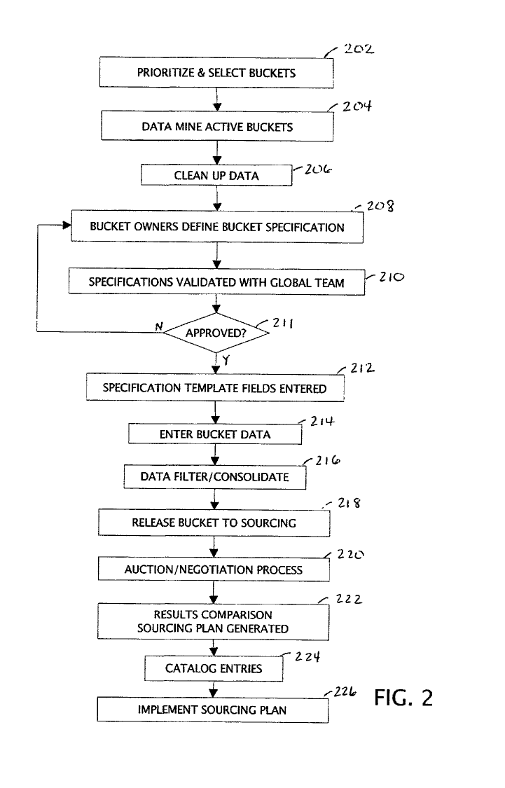

System 100 preferably includes a global team of representatives of the business enterprise for carrying out the processes described herein. Global team members generate specifications including standards for direct and indirect items, conduct auctions or negotiations for selected items and suppliers, and adopt a sourcing plan wherein suppliers/items are selected for future sourcing activities. Purchase orders are released by purchasing personnel as set forth in the sourcing plan and a catalog database is maintained to reflect the sourcing plan as well as any updates or modifications to the sourcing plan including changes to specifications. Global team members may be operating from cost out distribution network 110, one or more of site systems 130, or may be distributed throughout system 100. It will be understood that after writing the specifications for all the site direct and indirect items, the global team may not be needed, and this part of the process as described in FIG. 2 could be automated. Further, the business enterprise executing the cost out tool may optionally choose to implement the specification and sourcing functions for either of its direct items or indirect items as desired.

Auctions may be on-line transactions whereby items for sale are listed on a web site for bidding activities, or may be on-line transactions whereby items desired for purchase are listed at a web site for bidding by a supplier of the items. The on-line auction activities are well known and will be appreciated by those skilled in the art. This type of auction is sometimes referred to as reverse auction where the price charged is offered by the suppliers, and the prices offered show a downward trend. Negotiation may be by traditional back-and-forth offers and counteroffers between trading partners and are also well known in the art. Auction or negotiations output includes prices, parts/items descriptions, and preferred suppliers selected by the global team members of the business enterprise.

The global team preferably comprises a team leader, a plurality of pole leaders (e.g., regional leaders) for larger businesses, technical specialists, sourcing specialists, maintenance personnel, finance personnel, information technology (IT) personnel, and any additional personnel desired by the business enterprise. The team leaders oversee the activities performed by the global team members and support the processes described herein. Technical specialists format specification templates provided by the cost out tool according to the needs of the business enterprise and are assigned buckets, or specific items, for implementation. A bucket is one or more original equipment manufacturer (OEM) product(s) that share similar characteristics (e.g., valve, filter, pipes and fittings, belts, production supplies, etc.) Maintenance personnel assist in defining the specification templates and provide support to their assigned technical specialists. A bucket owner is a technical specialist who oversees the specification process for an assigned bucket and approves the final specification template before it is entered into a central database such as data storage device 116. Internet procurement (also referred to as I-procurement) personnel update local catalog databases at the site 130 upon the execution of a purchase or a change in the status of a purchase or specification template and ensure data is uploaded to a central storage location such as data storage device 116 for global access. It will be understood that this team process of developing the specifications may not be needed when all items are specified and standardized. In such a case, the process could be automated. At workstation 118, a sourcing leader of the global team invites potential suppliers and original equipment manufacturers (OEM's) at 140 to auction based on the bucket specification data in data storage device 116. This may be accomplished by disseminating specification data via a web site using an auction tool or similar system. Operating and maintenance teams at each of site systems 130 implement the auction or negotiations output (e.g., refrain from old purchasing patterns, use up or return existing inventory, etc.). Local reports and metrics may be generated at the site level as well as global reports via the cost out tool.

Operation of the system will now be described. FIG. 2 describes the specification set-up process in an exemplary embodiment of the invention. A global team, preferably comprised of team/pole leaders, finance personnel, IT support, technical and maintenance personnel, review existing bucket records. These records may be stored in more or more legacy storage devices such as legacy database 120 and/or a central storage system. As described above, a bucket is an OEM product with similar characteristics (e.g., valve, filter, pipes and fittings, belts, production supplies, etc.) During this review process, bucket records are selected and prioritized according to predefined criteria (e.g., active, critical parts, frequency of use/need, etc.) at step 202. Each of site systems 130 selects a person to oversee the data mining activities for active buckets stored locally in their systems at step 204. Active buckets are those that have shown recent activity (e.g., bucket items that have been ordered in the past 10 years, more preferably ordered in the past 5 years, and most preferably ordered in the past 3 years). Data is purged from the buckets for obsolete items or records at step 206 (e.g., a supplier goes out of business or a bucket item goes end-of-life). If available, such data mining could be pulled by a bucket leader from a global data base system.

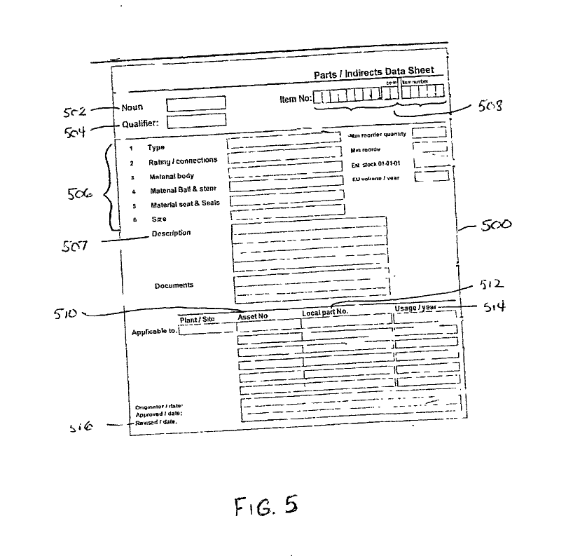

The resulting data are made available to a bucket owner appointed by the global team for defining bucket specifications at step 208. The bucket owner may be alerted to a request to implement this specification activity via email or other communications means initiated by a global team leader. Alternatively, the cost out tool may be configured to automatically notify some or all bucket owners of impending requests to perform bucket specifications upon their appointment as bucket owners. Bucket owners are technical specialists who have specialized knowledge, or have access to those that have specialized knowledge, of the items to which they are assigned. These bucket owners implement bucket specifications via the cost out tool by entering specific data into a specification template provided by the cost out tool. An exemplary specification template 500 (also referred to as specification data sheet) is shown in FIG. 5. Key qualifier fields 502 and 504 are designated by the bucket owner as well as specific attributes via a number of auxiliary fields 506. Key qualifiers and specific attributes describe and identify the bucket items and may come from ISO 10303 standards, current supplier data, and/or a databank of such attributes. Once this has been completed, the bucket owner validates these specifications with the global team at step 210. If the global team does not approve (211) of the defined specifications, the process reverts to step 208 wherein the bucket owner redefines the bucket specifications.

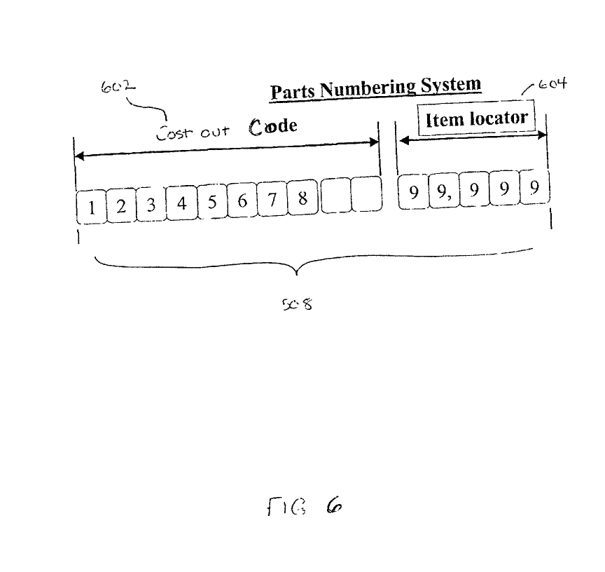

Upon approval (211) by the global team, a special code 508 is assigned that uniquely identifies this item. The code 508 can be assigned by a sourcing specialist or administrator of the global team with high-level access, or from locally or globally accepted nomenclature (e.g., a coding system such as the Universal Standard Products and Services Classification (UNSPSC) code developed by the Electronic Commerce Code Management Association (ECCMA), a non-profit organization). The code is described in further detail in FIG. 6. For bulk, generic items and spare parts (e.g., replacement items for bulk, generic components) that are common to most sites, this specification process may be performed by the global team technical specialist.

For site-specific items (e.g., items typically used only at one site) and site-specific spares (e.g., replacement items for site-specific components), the data may be sent to each site for additional specifications. Each of site systems 130 may define asset and usage data to the specifications via template 500 fields such as Asset number field 510, Local part number field 512, and Usage/Year field 514. Asset data includes information relating to the product or assembly that is associated with the specific item. Usage data refers to the amount, volume or quantity of each specific item that is used over a period of time scale chosen as a basis (e.g. 3, 6 or 9 months, 1 or 2 years).

The specification template fields of template 500 are entered into specification database 122 at step 212 in order to create a bucket specification. Alternatively, specification template fields may be entered at a local site and uploaded to specification database 122. Bucket data is then entered into the bucket specification at step 214. The bucket data entered may come from active buckets stored in legacy database 120 via a mapping tool subsequent to the data mining process of step 204. Bucket data may also be supplemented by manual entry of description data by maintenance personnel of the global team. Maintenance personnel may use the item description data from the description field 507 of specification template 500 to populate auxiliary fields 506. The cost out tool may be configured to provide for a second approval of the bucket by the bucket owner if desired. The resulting data is sent through a data filter for consolidation at step 216. Consolidation of bucket data includes aggregating bucket data from various site systems 130 and/or external sources via one or more of specification field entries provided in the bucket specifications. For example, bucket specifications that share a common code may be retrieved and aggregated for comparison and consolidation activities. The resulting consolidated information is released to sourcing specialists of the global team for auction or negotiations at step 218. It will be understood that the information in the templates could be derived from a large database, manufacturer and manufacturer part number or item model number or any other unique item description. This step of the operation could be outsourced or automated. Suppliers could also supply such information voluntarily or as part of the negotiation contract. Information that may be requested or required from a supplier during the auction or negotiation process includes supplier registration data, acceptable terms and conditions, delivery requirements or options, return policies, etc.

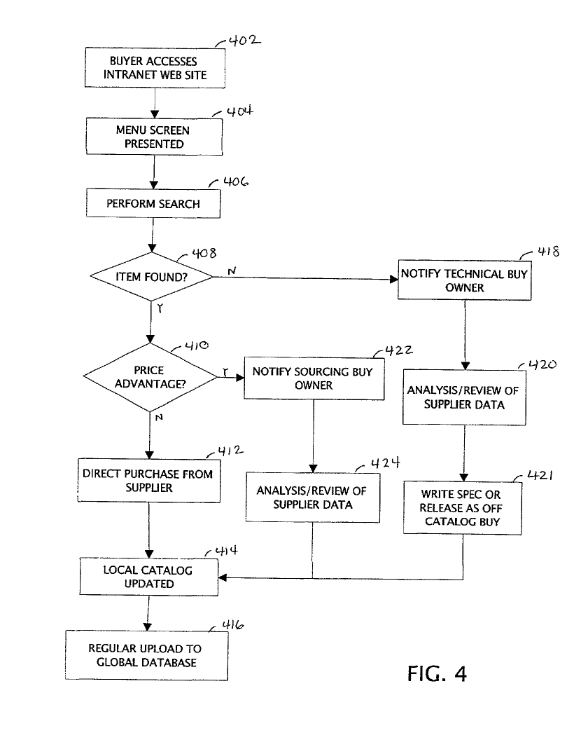

Auctions and/or negotiations are executed at step 220 via the cost out distribution network 110 and the cost out tool. The results of the auction/negotiation are analyzed where comparisons of the responding supplier systems 140 are completed for cost leveraging opportunities and a sourcing plan is generated based upon these results at step 222. The sourcing plan includes selecting preferred suppliers/parts/items for potentially exclusive and/or ongoing procurement activities. Site operating and maintenance personnel may be tasked with the responsibility of ensuring each site adheres to the sourcing plan. Procurement personnel ensure that these preferred suppliers/parts/items are catalogued and stored in local databases for execution at step 224. The resulting sourcing plan is ready for implementation at step 226 as will be described further in FIG. 4. Sites 130 may be required to procure only those items authorized by the sourcing plan. Modifications to the sourcing plan and/or to bucket specifications stored in the catalog database may be implemented by procurement personnel at each site and subsequently uploaded to a master catalog database such as catalog database 126.

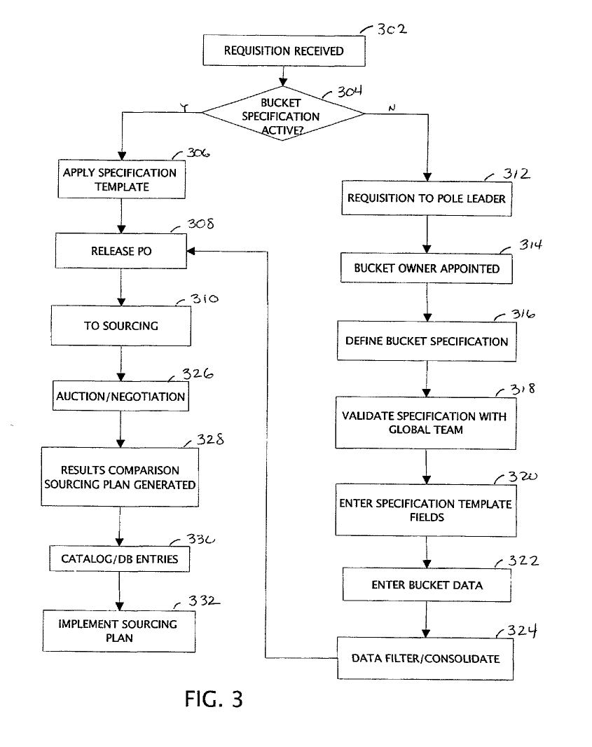

These bucket specification and sourcing processes are maintained over time to accommodate changes in requirements in order to ensure continued operability and success. In order to provide continuity, the cost out tool includes a maintenance process to implement these changes. An exemplary embodiment of the maintenance process is described in FIG. 3. A requisition is received by a procurement or purchasing entity at step 302. A requisition includes a request for the acquisition of materials that may not be carried or stocked at the requester's site. It is transmitted by the procurement entity to an assigned individual (preferably the same individual who oversees the data mining activities described in FIG. 2). It is determined whether the bucket specification relating to the requisition is active or not at step 304. If active, an existing specification template is applied to the requisition data at step 306. A purchase order for the requested items is released at step 308 and then sent to the sourcing entity for auction or negotiations at step 310.

If the bucket specification is not active, the requisition is transmitted to a global leader at step 312 where a bucket owner is appointed at step 314. The bucket owner defines a bucket specification at step 316 then validates the specification with the global team at step 318. The specification template fields are entered into the system at step 320 followed by the associated bucket data at step 322. A data filter is used to consolidate the data at step 324 and the resulting information is transmitted to a sourcing entity for release of a purchase order at step 308.

Auctions and/or negotiations are executed at step 326 via the cost out distribution network 110 and the cost out tool. The results of the auction/negotiation are analyzed where comparisons of the responding supplier systems 140 are completed for cost leveraging opportunities and a sourcing plan is generated based upon these results at step 328. The sourcing plan includes selecting preferred suppliers/parts/items for potentially exclusive and/or ongoing procurement activities. Site operating and maintenance personnel may be tasked with the responsibility of ensuring each site adheres to the sourcing plan. Procurement personnel ensure that these preferred suppliers/parts/items are catalogued and stored in local databases for execution at step 330. The resulting sourcing plan is ready for implementation at step 332 as described further in FIG. 4. Sites 130 may be required to procure only those items authorized by the sourcing plan. Modifications to the sourcing plan and/or to bucket specifications stored in the catalog database may be implemented by procurement personnel at each site and subsequently uploaded to a master catalog database such as catalog database 126.

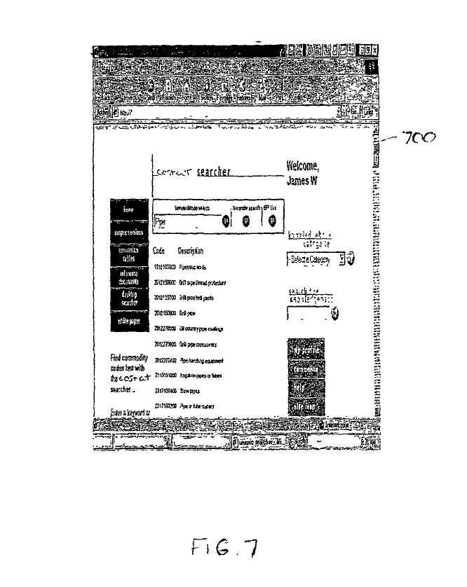

FIG. 4 illustrates the process of initiating a purchase for items. A buyer of the business enterprise accesses the cost out tool web site at step 402. A menu screen is presented at step 404. A sample menu screen 700 is illustrated in FIG. 7. The buyer performs a search for a desired item at step 406. Searches may be conducted via the search engine component of the cost out tool as shown generally in FIG. 7. Key words or qualifiers such as those found in fields 502 and 504 of FIG. 5, assigned codes 508, or other criteria may be used to search for items utilizing the cost out tool search engine. The system searches specification database 122 for a match at step 408. If the item is found, the buyer has the option of comparing the prices provided in the database for the item against currently available pricing known to the buyer at step 410. If the price stated in the specification is acceptable, the buyer, if authorized, may directly purchase the item from the supplier at this time at step 412. Purchases can be made electronically via electronic purchase cards, e-checkbooks, or other financial transaction software known in the art. The local database is updated at the site to reflect this purchase at step 414. Periodically, site systems 130 upload this and other purchases/changes to a global catalog database in data storage device 116 such as catalog database 126 at step 416.

If the item is not found in the system, either the buyer notifies a technical member of the global management team associated with this item or an automatic notice is transmitted to the technical member of this situation at step 418. The technical member reviews the information and decides whether to change the preferred parts/items/suppliers accordingly at step 420. The technical member is provided with one of two options at step 421. The first option involves writing a specification for the item as described in FIG. 3. The second option relates to critical situations such as where the item is needed immediately and there is insufficient time to wait for a specification to be processed. In this case, the technical member may authorize the acquisition of the item as an “off catalog” buy which involves procuring the item outside of the cost out system. In either event, the catalog is updated at step 414 and once again, the information is uploaded to global database at data storage device 116 at step 416.

If the item was found and the buyer is aware of a price advantage not reflected in the current specification, either the buyer or the cost out tool notifies a sourcing specialist of the global team of this information at step 422. Analysis is performed at step 424 in order to determine whether to change the current specification. Any changes made are updated in the catalog at step 414 and once again, the data is uploaded to the global database stored in data storage device 116 at step 416.

FIG. 6 illustrates an exemplary code structure 508 for identifying, classifying, and organizing direct and indirect items in a global storage device such as data storage device 116. As described earlier, the code may comprise a unique numeric or alphanumeric identification 602 assigned by the business enterprise that may be proprietary in nature or may be an existing code structure adopted by and used in the procurement industry such as UNSPSC code structure. The code may be configured to provide numeric or alphanumeric representations of items by commodity types or similar classification categories. The code also comprises an item locator 604 that enables the cost out tool to further classify items, providing a more comprehensive classification scheme. Although item locator 604 as shown in FIG. 6 comprises a five-digit designator, it will be understood that locator 604 include more than or less than five digits in order to realize the advantages of the present invention. The additional item locator portion of the code allows for more productive searches of items, particularly for storage systems where a vast amount of items are warehoused. For example, the cost out tool may classify an item “pipe” with additional specifiers “carbon steel pipe” for greater visibility. In a preferred embodiment, cost out code 602 identifies buckets and item locator 604 identifies specific items (e.g., direct and/or indirect parts) within a particular bucket.

The cost out tool provides benefits and opportunities to various entities of a business enterprise. In addition to the convenience of utilizing a standardized database of direct and indirect items, a sourcing department may benefit by consolidating records of procurement items in order to obtain cost leverage for volume purchases on a global platform. Operations departments may benefit by having readily available items and a reliable means to obtain reserve items from its related operations sites located nearby as the cost out tool allows for greater visibility of specific resources. Finance groups may benefit by enhanced cash flow through a centralized cost out accounting network and manufacturing departments can benefit from increased productivity.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The present invention could also be implemented manually or by using both manual and automated method at any combinations of appropriate levels.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

1. A network system for facilitating procurement of direct and indirect items via a cost out tool, comprising:
at least one cost out distribution network system, comprising:
a server operable for executing said cost out tool;
a communications network operably coupled to said server;
a workstation in communication with said server via said communications network, said workstation executing a user interface for facilitating execution of said cost out tool;
a data storage device in communication with said server via said communications network, said data storage device housing information utilized by said server in executing said cost out tool, wherein said information includes:
legacy data;
bucket specifications and specification templates;
sourcing data; and
a catalog of selected items and suppliers;
a link to at least one supplier system;
at least one site system operably coupled to said at least one cost out distribution network system and said at least one supplier system via said network system, said at least one site system comprising:
a web-enabled computer processing device coupled to a local storage device via a communications link wherein said computer processing device executes a graphical user interface.

2. The network system of claim 1, further comprising:
a code structure incorporated into said catalog including a specification code and an item locator for classifying and organizing said direct and indirect items.

3. The network system of claim 2, wherein said specification code is provided by a commercial coding system.

4. The network system of claim 2, wherein said specification code is a commodity code provided by an administrator or a sourcing specialist associated with said cost out distribution network system.

5. The network system of claim 2, wherein said item locator is a code comprising at least one digit operable for providing sub-classifications among each of said specification codes.

6. The network system of claim 1, further comprising:
a mapping tool executing on said server operable for transferring selected legacy data to at least one of said bucket specifications.

7. The network system of claim 1, further comprising:
an auction tool executing on said server operable for communicating said bucket specifications to, and receiving responses from, said at least one supplier system.

8. The network system of claim 1, further comprising:
an electronic purchasing tool executing on said server operable for:
generating purchase orders;
executing purchases; and
performing related billing functions.

9. The network system of claim 1, wherein said network system communicates via at least one of:
an extranet; and
Internet.

10. The network system of claim 1, wherein said at least one cost out distribution network system includes a central facility for said facilitating procurement of direct and indirect items via negotiations and auctions on behalf of said at least one site system and said at least one supplier system.

11. The network system of claim 1, wherein said legacy data includes at least one of:
supplier listings including product offerings and contact information;
bucket records of direct items including descriptions, pricing, purchase history, and status information; and
bucket records of indirect items including descriptions, pricing, purchase history, and status information.

12. The network system of claim 11, wherein said status information includes designating an active status or inactive status to said bucket records indicating a time measurement of activity.

13. The network system of claim 1, wherein said bucket specifications each include classification criteria including:
at least one key qualifier;
attributes;
auxiliary data; and
an assigned code.

14. The network system of claim 13, wherein said bucket specifications each include:
a description field;
asset data;
usage data;
an originator name;
an originator date; and
if edited:
an editor name; and
an edit date.

15. The network system of claim 14, wherein said asset data includes local data unique to a site system, said local data identifying items provided in said bucket specifications.

16. The network system of claim 14, wherein said usage data includes local data specific to an associated site system relating to a nature of use of items provided in said bucket specification.

17. The network system of claim 16, wherein said usage data includes local data specific to an associated site system relating to units of measurement associated with said items provided in said bucket specification.

18. The network system of claim 1, further comprising bucket data including information relating to said direct or indirect items provided in said bucket specifications.

19. The network system of claim 1, wherein said catalog houses information relating to direct and indirect items designated for sourcing and procurement.

20. The network system of claim 1, wherein said catalog stores sourcing plans developed as a result of analyses performed on supplier responses to auctions and negotiations, said sourcing plans including instructions for procurement of direct and indirect items.

21. The network system of claim 1, wherein said cost out tool includes a search engine for facilitating searching of direct and indirect items in said catalog.

22. The network system of claim 1, wherein said cost out distribution network system is implemented at said at least one site system.

23. A cost out tool for facilitating procurement of direct and indirect items via a network system, comprising:
at least one database housing:
specification templates;
bucket specifications;
bucket data for populating fields provided in said bucket specifications;
sourcing data;
at least one sourcing plan, said at least one sourcing plan including instructions for executing procurement activities among site systems and preferred suppliers, and wherein further, said sourcing plan resulting from auction or negotiation processes carried out via said cost out tool;
at least one catalog housing sourcing information pursuant to said sourcing plan;
an editing tool for modifying said bucket specifications; and
a reporting tool for providing metrics and reports.

24. The cost out tool of claim 23, wherein said site systems:
execute said sourcing plan;
update data in local storage to reflect sourcing activities executed; and
periodically upload said data in local storage to a master catalog maintained by said cost out tool.

25. A method for facilitating procurement of direct and indirect items over a network system, comprising:
implementing a set-up process, including:
selecting and prioritizing bucket records stored in a legacy database according to predefined criteria, said bucket records comprising data related to said direct and indirect items;
data mining said bucket records;
providing a specification template operable for:
defining bucket specification criteria;
assigning a unique code to said specification criteria; and
entering bucket specification fields into a database;
entering bucket data into said bucket specification fields;
consolidating said bucket data;
releasing said bucket data to a sourcing entity; and
conducting a preferred supplier selection process resulting in a sourcing plan; and
storing results of said supplier selection process in a catalog database.

26. The method of claim 25, wherein said data mining said bucket records includes:
assigning an inactive status to bucket records determined to be obsolete, duplicative, or otherwise undesirable;
assigning an active status to remaining bucket records; and
storing updated bucket records and status assignments in said legacy database.

27. The method of claim 25, wherein said bucket specification criteria are selected from information sources including at least one of:
ISO standards;
supplier-provided data; and
databanks.

28. The method of claim 25, wherein said unique code includes:
a specification code for classifying and organizing bucket specifications; and
an item locator for sub-classifying said bucket specifications.

29. The method of claim 25, wherein said entering said bucket specification criteria into said bucket specification fields includes transferring bucket data from a legacy database into associated bucket specification fields.

30. The method of claim 25, wherein said consolidating said bucket data includes aggregating bucket data using said unique code.

31. The method of claim 25, wherein said conducting a preferred supplier selection process includes:
distributing aggregated bucket data to selected supplier systems including an invitation to bid or negotiate;
comparing responses from said supplier systems, said responses including acceptance of said invitation.

32. The method of claim 31, wherein said acceptance includes agreement to adhere to required or requested terms and conditions of said invitation.

33. The method of claim 32, wherein said terms and conditions include:
descriptions of items required;
quantities of said items;
delivery methods;
site services;
technical support; and
return policies.

34. The method of claim 25, wherein said sourcing plan includes acceptable methods of procuring direct and indirect items for implementation by designated site systems.

35. The method of claim 25, wherein said catalog database houses preferred supplier systems data and preferred direct and indirect item data pursuant to said sourcing plan.

36. A method for facilitating procurement of direct and indirect items, comprising:
implementing a maintenance process, including:
receiving a requisition for at least one direct or indirect item;
determining a status of a bucket specification related to said direct or indirect item;
if said status is active:
applying a specification template;
releasing a purchase order;
transmitting said purchase order to a sourcing entity; and
conducting a preferred supplier selection process; and
if said status is not active:
appointing a bucket owner;
defining a bucket specification via a specification template;
assigning a unique code to said items;
entering bucket specification fields into a database;
consolidating said bucket data;
releasing said bucket data to said sourcing entity; and
conducting a preferred supplier selection process.

37. The method of claim 36, further comprising initiating a purchase for a direct or indirect item, including:
accessing a cost out tool by a user at a workstation;
upon being presented with a menu screen, performing a search for a desired item;
if said item is found in said database:
comparing prices provided by said tool for said item with recently obtained pricing information known to said user;
if said user is aware of a potential price advantage not specified in said database:
notifying said sourcing of said potential price advantage;
analyzing elements of said potential price advantage against existing database records;
if said sourcing entity determines that said price advantage merits a modification:
modifying existing specification records to reflect said price advantage; and
updating said records in said database to reflect said modification;
if authorized, directly purchasing said item from a preferred supplier system provided by said cost out tool;
if not authorized, purchasing said item through alternative procurement channels; and
updating a database catalog to reflect said purchase;
if said item is not found in said database:
notifying a designated technical specialist; and
reviewing data reported and determining whether to modify existing bucket records, wherein said records are modified if criteria is met.

38. A storage medium encoded with machine-readable computer program code for facilitating procurement of direct and indirect items over a network system, the storage medium including instructions for causing a computer to implement a method, comprising:
implementing a set-up process, including:
selecting and prioritizing bucket records stored in a legacy database according to predefined criteria, said bucket records comprising data related to said direct and indirect items;
data mining said bucket records;
providing a specification template operable for:
defining bucket specification criteria;
assigning a unique code to said specification criteria; and
entering bucket specification fields into a database;
entering bucket data into said bucket specification fields;
consolidating said bucket data;
releasing said bucket data to a sourcing entity; and
conducting a preferred supplier selection process resulting in a sourcing plan; and
storing results of said supplier selection process in a catalog database.

39. The storage medium of claim 38, wherein said data mining said bucket records includes:
assigning an inactive status to bucket records determined to be obsolete, duplicative, or otherwise undesirable;
assigning an active status to remaining bucket records; and
storing updated bucket records and status assignments in said legacy database.

40. The storage medium of claim 38, wherein said bucket specification criteria are selected from information sources including at least one of:
ISO standards;
supplier-provided data; and
databanks.

41. The storage medium of claim 38, wherein said unique code includes:
a specification code for classifying and organizing bucket specifications; and
an item locator for sub-classifying said bucket specifications.

42. The storage medium of claim 38, wherein said entering said bucket specification criteria into said bucket specification fields includes transferring bucket data from a legacy database into associated bucket specification fields.

43. The storage medium of claim 38, wherein said consolidating said bucket data includes aggregating bucket data using said unique code.

44. The storage medium of claim 38, wherein said conducting a preferred supplier selection process includes:
distributing aggregated bucket data to selected supplier systems including an invitation to bid or negotiate;
comparing responses from said supplier systems, said responses including acceptance of said invitation.

45. The storage medium of claim 44, wherein said acceptance includes agreement to adhere to required or requested terms and conditions of said invitation.

46. The storage medium of claim 45, wherein said terms and conditions include:
descriptions of items required;
quantities of said items;
delivery methods; and
return policies.

47. The storage medium of claim 38, wherein said sourcing plan includes acceptable methods of procuring direct and indirect items for implementation by designated site systems.

48. The storage medium of claim 38, wherein said catalog database houses preferred supplier systems data and preferred direct and indirect item data pursuant to said sourcing plan.

49. A storage medium encoded with machine-readable computer program code for facilitating procurement of direct and indirect items, the storage medium including instructions for causing a computer to facilitate implementation of a method comprising:
implementing a maintenance process, including:
receiving a requisition for at least one direct or indirect item;
determining a status of a bucket specification related to said direct or indirect item;
if active:
applying a specification template;
releasing a purchase order;
transmitting said purchase order to a sourcing entity; and
conducting a preferred supplier selection process; and
if not active:
appointing a bucket owner;
defining a bucket specification via a specification template;
assigning a unique code to said items;
entering bucket specification fields into a database;
consolidating said bucket data;
releasing said bucket data to said sourcing entity; and
conducting a preferred supplier selection process.

50. The storage medium of claim 49, further comprising instructions for causing said computer to facilitate implementation of a method, comprising:
initiating a purchase for a direct or indirect item, including:
accessing a cost out tool by a user at a workstation;
upon being presented with a menu screen, performing a search for a desired item;
if said item is found in said database:
comparing prices provided by said tool for said item with recently obtained pricing information known to said user;
if said user is aware of a potential price advantage not specified in said database:
notifying said sourcing of said potential price advantage;
analyzing elements of said potential price advantage against existing database records;
if said sourcing entity determines that said price advantage merits a modification:
modifying existing specification records to reflect said price advantage; and
updating said records in said database to reflect said modification;
if authorized, directly purchasing said item from a preferred supplier system provided by said cost out tool;
if not authorized, purchasing said item through alternative procurement channels; and
updating a database catalog to reflect said purchase;
if said item is not found in said database:
notifying a designated technical specialist; and
reviewing data reported and determining whether to modify existing bucket records, wherein said records are modified if criteria is met.
